(19) United States
(12) Patent Application Publication
(10) Pub. No.: US 2015/0141139 A1
(43) Pub. Date: May 21, 2015

(54) PRESENTING TIME-SHIFTED MEDIA CONTENT ITEMS

(71) Applicant: Microsoft Corporation, Redmond, WA (US)

(72) Inventors: Steven Trombetta, Seattle, WA (US); Janice M. Von Itter, Seattle, WA (US); Emily Denise Comfort, Seattle, WA (US)

(73) Assignee: Microsoft Corporation, Redmond, WA (US)

(21) Appl. No.: 14/084,401

(22) Filed: Nov. 19, 2013

(51) Int. Cl. G06F 3/0484; A63F 13/85; A63F 13/52; A63F 13/63; G06F 3/0482; G11B 27/30

(52) U.S. Cl. CPC G06F 3/0484; G06F 3/0482; G11B 27/309; A63F 13/52; A63F 13/63; A63F 13/85
USPC 463/31; 715/716

(57) ABSTRACT

A user interface for visually presenting media content items available for time-shifted playback. The user interface includes a first plurality of preview images having an aspect ratio and a first size. The user interface also includes a second plurality of preview images having the same aspect ratio and a second size, smaller than the first size. Each preview image visually represents a different media content item available for time-shifted playback. Each preview image is spatially-sorted in an array according to a temporal order with which that media content item is added to the array. Preview images having the first size alternate between being aligned above and being aligned below two side-by-side preview images having the second size.

### BACKGROUND

Home entertainment devices such as game consoles, set-top boxes, tablet computers, mobile phones, and personal computers can be used to access media content items such as movies, television programs, songs, games, and various other audio and/or visual content items. As the number of available options increases, it becomes more difficult to provide a user with all available options in an easy-to-navigate, easy-to-find, and aesthetically pleasing manner.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Various computer-implemented user interfaces for visually presenting media content items available for time-shifted playback are disclosed. The user interfaces include a first plurality of preview images having an aspect ratio and a first size. The user interfaces also include a second plurality of preview images having the same aspect ratio and a second size, smaller than the first size. Each preview image visually represents a different media content item available for time-shifted playback. Each preview image is spatially-sorted in an array according to a temporal order with which that media content item is added to the array. Preview images having the first size alternate between being aligned above and being aligned below two side-by-side preview images having the second size.

### BRIEF DESCRIPTION OF THE DRAWINGS

FIG. 1 shows an example computer-implemented user interface in accordance with an embodiment of the present disclosure.

FIGS. 2A-2D schematically show various computer-implemented user interfaces in accordance with different embodiments of the present disclosure.

FIG. 3 shows an example method of visually presenting previously-recorded game clips available for time-shifted playback.

FIG. 4 shows an example computing system configured to implement user interfaces in accordance with the present disclosure.

### DETAILED DESCRIPTION

A computer-implemented user interface for visually presenting media content items available for time-shifted playback is described below. In particular, the disclosed user interface provides a visually distinctive and aesthetically pleasing mechanism for presenting long lists. The disclosed user interface advantageously maintains a sorting of the list contents. While time-shifted playback of media content items is used as an example, it is to be understood that the disclosed user interface may be used with virtually any list. Likewise, while the examples provided below are directed to temporally sorted lists, it is to be understood that virtually any other type of sorting may be used.

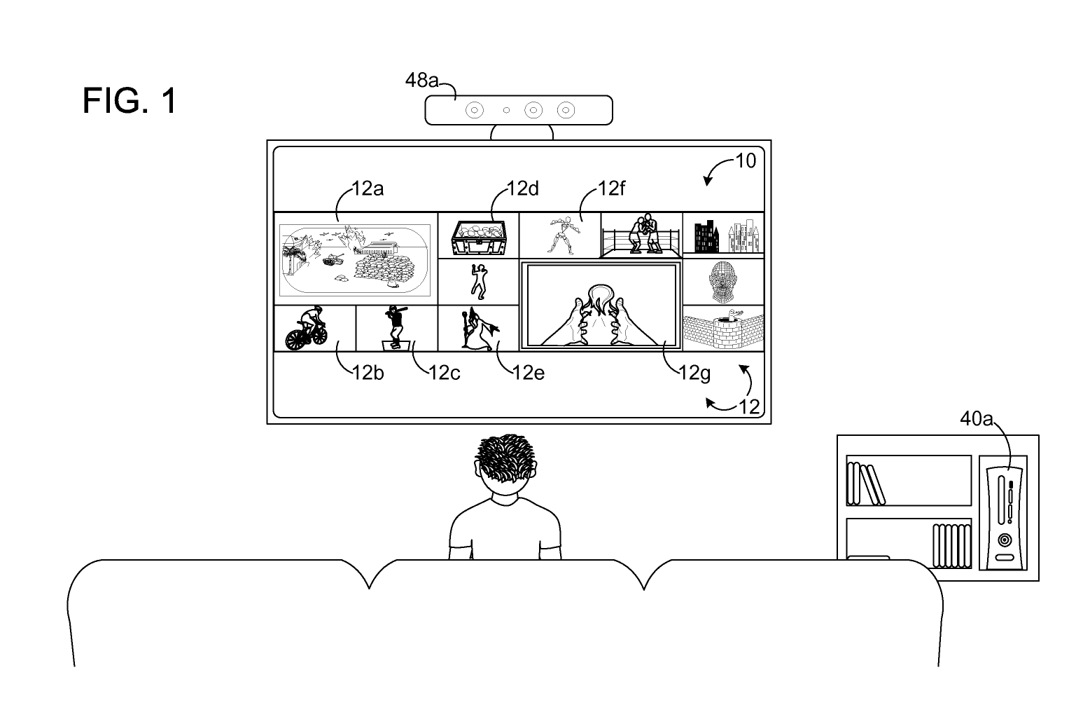

FIG. 1 shows a nonlimiting example of a computer-implemented user interface 10 that includes preview images 12 (e.g., preview image 12a, 12b, . . . 12f) that each visually represents a different media content item available for time-shifted playback. In the illustrated example, each preview image is a thumbnail from a corresponding game clip (i.e., an image that was displayed by the game when the game was recorded). However, preview images can take virtually any form. As another example, the preview images may include cover art and/or other graphics indicative of the media content item available for time-shifted playback.

The different preview images may have two or more different sizes. As illustrated, user interface 10 includes a plurality of preview images of a relatively large size (e.g., preview image 12a and preview image 12g), and a different plurality of preview images of a relatively small size (e.g., preview image 12b, preview image 12c, preview image 12d, etc.). While not shown, it is to be understood that preview images may have three or more different sizes.

The differently sized preview images may have the same aspect ratio. As illustrated, all preview images 12 have a 16×9 aspect ratio. Because all preview images have the same aspect ratio, a single preview image may be used in either the large or small size. While a 16×9 aspect ratio is provided as an example, other aspect ratios may be used. Furthermore, though not illustrated, it is to be understood that some preview images may have different aspect ratios than other preview images.

In the illustrated example, large preview images have a 16×9 aspect ratio with a 754 pixel width and a 424 pixel height; and small preview images have a 16×9 aspect ratio with either a 370 pixel width and a 208 pixel height, or a 373 pixel width and a 208 pixel height. As demonstrated in this example, the small preview images may vary in size by a small amount (e.g., less than 1%). Such variation may be beneficial when fitting several columns and/or rows of preview images into a predefined space and/or when aligning two side-by-side small preview images above or below one large preview image. For example, small preview images aligned above or below a large preview image (e.g., preview image 12b and preview image 12c) may be larger or smaller than small preview images that are not aligned above or below a large preview image (e.g., preview image 12d and preview image 12f).

In the above example, the widths of the small preview images differ by 3 pixels while the heights match. Both of the small preview images are within 1% of an exact 16×9 aspect ratio (e.g., 1.760 to 1.796). While not illustrated, it is to be understood that the precise pixel size of a preview image may be altered by more than 1% from an exact aspect ratio (e.g., <2% or <3%). For purposes of this disclosure, because the small size differences are not apparent to a human user, both the 370 pixel wide and 373 pixel wide preview images may be considered to be the same small size. The example sizes and aspect ratios provided above are not intended to be limiting. The disclosed user interface may be used with preview images having virtually any size(s) and/or aspect ratio(s).

In the illustrated example, each preview image is spatially sorted in an array according to a temporal order with which that media content item is added to the array. As an example, preview images corresponding to more-recently-added media content items may be positioned more leftward and/or upward than preview images corresponding to less-recently-added media content items. Some arrays may be arranged such that preview images having the large size alternate between being aligned above and being aligned below two side-by-side preview images having the small size. In this arrangement, all large-size preview images for less-recently-added media content items may be positioned rightward of large-size preview images for more-recently-added media content items.

While user interface 10 is illustrated as simultaneously displaying twelve preview images, it should be understood that the preview images may be scrolled to reveal different preview images corresponding to other media content items available for time-shifted playback.

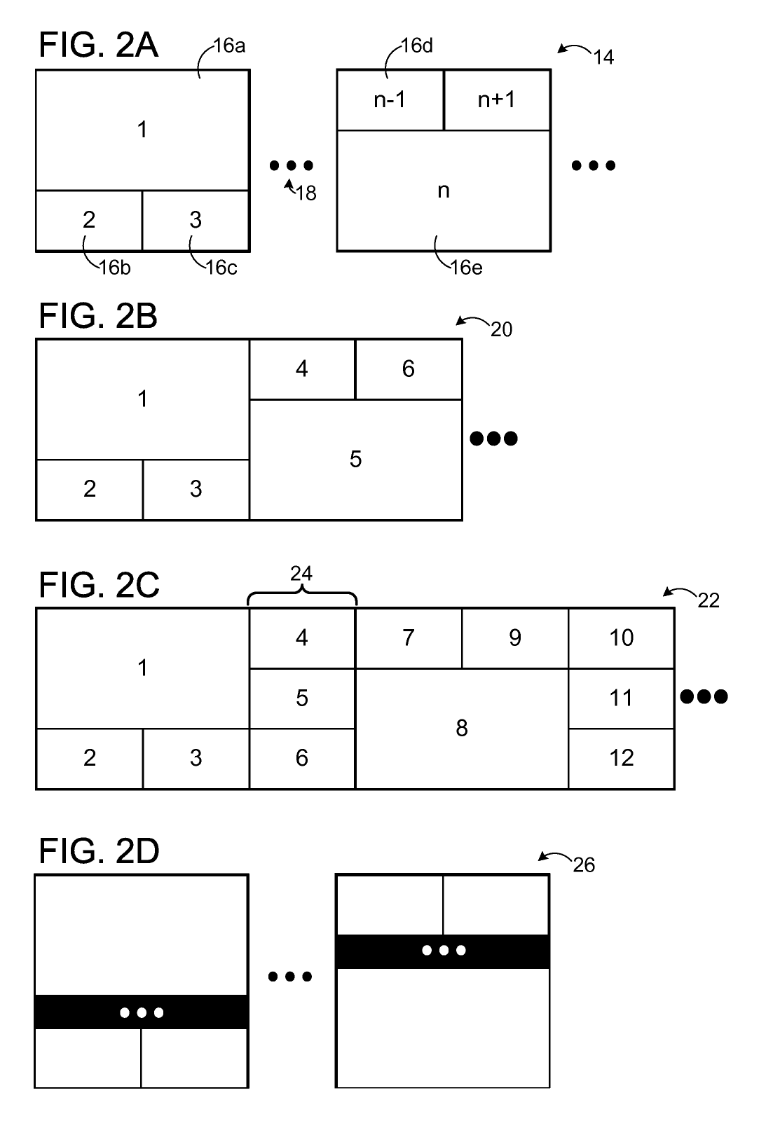

FIGS. 2A-2D show non-limiting examples of different user interface array configurations in accordance with the present disclosure. It is to be understood that while the preview images may take various graphical forms, in FIGS. 2A-2C the preview images are schematically illustrated with numerical indices that signify the positions of the preview images within the array. As illustrated, lower indexes correspond to more-recently added media content items.

As an example, FIG. 2A shows a computer-implemented user interface 14 for visually presenting media content items available for time-shifted playback. User interface 14 includes a first preview image 16a visually representing a most-recent addition to an ordered listing of media content items accessible for time-shifted playback. Preview image 16a has a relatively large size and a 16×9 aspect ratio.

User interface 14 further includes a second preview image 16b visually representing a second-most-recent addition to the ordered listing of media content items accessible for time-shifted playback. Preview image 16b is left-aligned with and below preview image 16a. In other words, the left edge of preview image 16b is below the left edge of preview image 16a.

To the right of preview image 16b is a third preview image 16c visually representing a third-most-recent addition to the ordered listing of media content items accessible for time-shifted playback. Preview image 16c is right-aligned with and below preview image 16a. In other words, the right edge of preview image 16c is below the right edge of preview image 16a. Further, preview image 16c is top-and-bottom-aligned with and to the right of preview image 16b. Preview images 16b and 16c have the same relatively small size and a 16×9 aspect ratio.

As indicated by dots 18, user interface 14 may include zero or more columns that each include three relatively small preview images that are vertically aligned. As examples, FIG. 2B shows a user interface 20 that includes zero such columns, and FIG. 2C shows a user interface 22 that includes one such column 24. As discussed in more detail below, user interface 20 has m=0 spacing (i.e., zero intermediate columns between large preview images) and user interface 22 has m=1 spacing (i.e., one intermediate column between large preview images). Virtually any spacing can be used.

Returning to FIG. 2A, user interface 14 further includes an n^{th}−1 preview image 16d visually representing an n^{th}-minus-one-most-recent addition to the ordered listing of media content items accessible for time-shifted playback. Preview image 16d is top-aligned with and to the right of preview image 16a. Preview image 16d has a 16×9 aspect ratio and the same relatively small size as preview image 16b and preview image 16c.

User interface 14 further includes an n^{th} preview image 16e visually representing an n^{th}-most-recent addition to the ordered listing of media content items accessible for time-shifted playback. Preview image 16e is bottom-aligned with and to the right of preview image 16b and preview image 16c. Preview image 16e has a 16×9 aspect ratio and the same relatively large size as preview image 16a.

As introduced above, user interface 14 includes some preview images that are relatively large and some preview images that are relatively small. The relatively large preview images are the preview images having spatially-sorted positions in a specific repeating pattern, while the relatively small preview images are the preview images not having spatially-sorted positions in the specific repeating pattern. Using the m=0 example of FIG. 2B, the repeating pattern is 1, 5, 7, 11, 13, 17, 19, etc. As such, the first, fifth, seventh, etc. preview images have the relatively large size while all other preview images have the relatively small size. Using the m=1 example of FIG. 2C, the repeating pattern is 1, 8, 13, 20, 25, 32, 37, etc. As such, the first, eighth, thirteenth, etc. preview images have the relatively large size while all other preview images have the relatively small size. While not shown, the repeating pattern for an m=2 spacing would be 1, 11, 19, 29, 37, 47, 55, etc.; and the repeating pattern for an m=3 spacing would be 1, 14, 25, 38, 49, 62, 73, etc. In general, the spatially-sorted position of an n^{th} preview image in the repeating pattern is:

$${a}_{n} = \frac{6 ( m + 1 ) ( n - 1 ) + 3 + {( - 1 )}^{n}}{2}$$

where m is an order of spacing within the array (e.g., m=0, m=1, m=2, etc.).

FIGS. 2A, 2B, and 2C all show example user interfaces in which each column either includes three vertically-aligned small preview images or one large preview image aligned above or below two side-by-side preview images. However, it is to be understood that other arrangements may be used. As an example, FIG. 2D shows a horizontally orientated user interface 26 that may include additional large and/or small preview images in each column. Virtually any number of large or small preview images may be added to each column in virtually any arrangement that satisfies a valid repeating pattern. As one example, each large preview image may be aligned above or below two rows of side-by-side small preview images. As another example, some large preview images may be aligned above and below different rows of side-by-side preview images. While the above-described arrangements are horizontally orientated and configured for horizontal scrolling, some arrangements may be vertically orientated and configured for vertical scrolling.

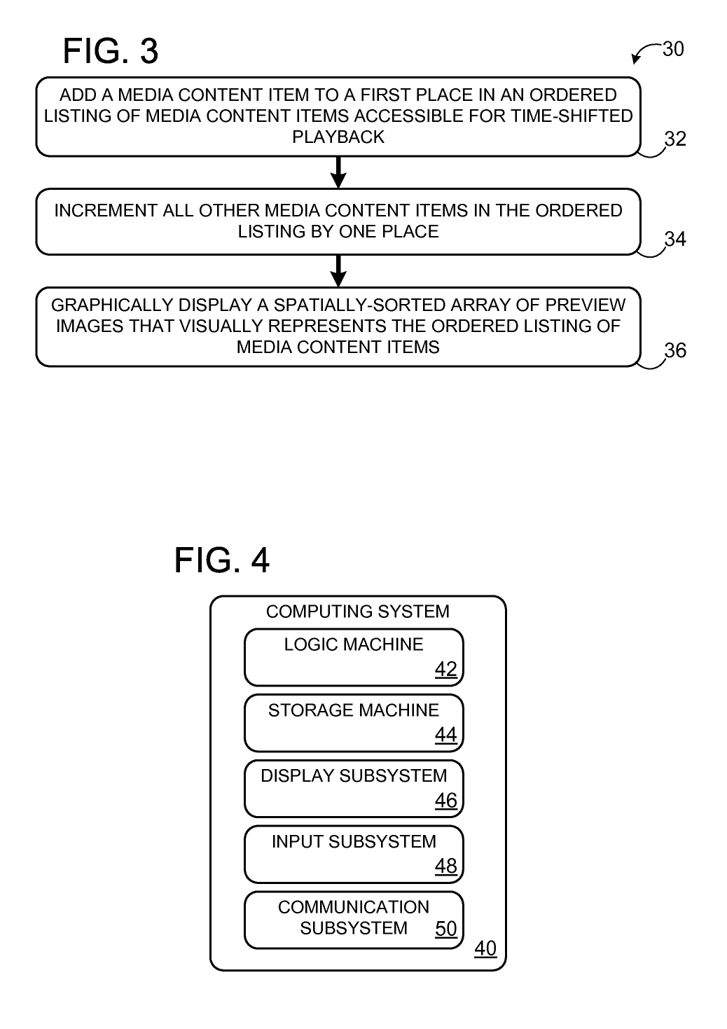

FIG. 3 shows a computer-implemented method 30 of visually presenting previously-recorded game clips available for time-shifted playback. Method 30 may be implemented by a computing system such as console gaming machine 40a of FIG. 1 or computing system 40 of FIG. 4.

At 32, method 30 includes adding a media content item to a first place in an ordered listing of media content items accessible for time-shifted playback. For example, a “clip-save” command may be issued to a computing device on which a computing game is being played. The computing device may then, responsive to the clip-save command, automatically add a game clip from the currently playing game to the first place in the ordered listing. As a nonlimiting example, the game clip may be a recording of the previous 30 seconds (or other duration) of gameplay. To facilitate this type of saving, the computing device may use a buffer to save encoded video (e.g., h.264, MPEG4, etc.) corresponding to the graphic images provided by the computing device's graphical processing unit to the computing device's display.

A clip save command may be automatically issued (e.g., on behalf of the user). For example, a game may automatically issue a clip save command responsive to the occurrence of a predetermined game event (e.g., sport's game score, platform game boss defeat, multi-player game friend encounter, etc.). Virtually any game event can be used to trigger a clip save command. Furthermore, the duration of the clip can be automatically trimmed according to virtually any suitable game logic (e.g., begin clip with snap of football and end clip with end of touchdown celebration dance).

A clip save command may alternatively and/or additionally be issued by a user. In other words, a user may instruct the computing device to save a specific segment of a game, even if the game is not automatically configured to save that segment. A user command may be issued in any suitable manner. For example, a button press, button sequence, or option menu may be used to issue a user command. As another example, a computing device may include a microphone and a speech recognition engine that allows a user to speak a voice command (e.g., “record that”) while a game is being played. As yet another example, the user command may be a gesture command recognized with a camera (e.g., camera 48a of FIG. 1).

At 32, method 30 further includes incrementing all other media content items in the ordered listing by one place. In other words, the media content item that was previously in the first place is incremented to the second place, the media content item that was previously in the second place is incremented to the third place, and so on. In this way, the place of the media content item within the ordered listing corresponds to the temporal order with which that media content item was added to the ordered listing. The most recently added media content item has the first place, the next most recently added media content item has the second place, etc.

At 36, method 30 includes graphically displaying a spatially-sorted array of preview images that visually represents the ordered listing of media content items. FIGS. 1, 2A, 2B, 2C, and 2D and their corresponding descriptions provide nonlimiting examples of such spatially-sorted arrays.

A user may use the spatially-sorted array to choose a content item to play. For example, a user may select a preview image corresponding to a desired content item. Such selection may be made using voice, touch, gesture, gaze, game control, remote control, mouse, trackpad, and/or any other suitable input mechanism.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 4 schematically shows a non-limiting embodiment of a computing system 40 that can enact one or more of the methods and processes described above. Computing system 40 is shown in simplified form. Computing system 40 may take the form of one or more gaming devices, personal computers, server computers, tablet computers, home-entertainment computers, network computing devices, mobile computing devices, mobile communication devices (e.g., smart phone), and/or other computing devices. Console gaming machine 40a of FIG. 1 is a nonlimiting example of a computing system 40.

Computing system 40 includes a logic machine 42 and a storage machine 44. Computing system 40 may optionally include a display subsystem 46, input subsystem 48, communication subsystem 50, and/or other components not shown in FIG. 4.

Logic machine 42 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 44 includes one or more physical devices configured to hold instructions executable by the logic machine to implement the methods and processes described herein. When such methods and processes are implemented, the state of storage machine 44 may be transformed—e.g., to hold different data.

Storage machine 44 may include removable and/or built-in devices. Storage machine 44 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 44 may include volatile, nonvolatile, dynamic, static, read/write, read-only, random-access, sequential-access, location-addressable, file-addressable, and/or content-addressable devices.

It will be appreciated that storage machine 44 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 42 and storage machine 44 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 40 implemented to perform a particular function. In some cases, a module, program, or engine may be instantiated via logic machine 42 executing instructions held by storage machine 44. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 46 may be used to present a visual representation of data held by storage machine 44. This visual representation may take the form of a graphical user interface (e.g., user interface 10 of FIG. 1). As the herein described methods and processes change the data held by the storage machine, and thus transform the state of the storage machine, the state of display subsystem 46 may likewise be transformed to visually represent changes in the underlying data. Display subsystem 46 may include one or more display devices utilizing virtually any type of technology. Such display devices may be combined with logic machine 42 and/or storage machine 44 in a shared enclosure, or such display devices may be peripheral display devices.

When included, input subsystem 48 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition (e.g., camera 48a of FIG. 1); a head tracker, eye tracker, accelerometer, and/or gyroscope for motion detection and/or intent recognition.

When included, communication subsystem 50 may be configured to communicatively couple computing system 40 with one or more other computing devices. Communication subsystem 50 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 40 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A computer-implemented method of visually presenting previously-recorded game clips available for time-shifted playback, the method comprising:
adding a game clip to a first place in an ordered listing of game clips accessible for time-shifted playback;
incrementing all other game clips in the ordered listing by one place; and
graphically displaying a spatially-sorted array of game-clip preview images that visually represents the ordered listing.

2. The computer-implemented method of claim 1, where the spatially-sorted array of game-clip preview images includes game-clip preview images having a first size and game-clip preview images having a second size, smaller than the first size.

3. The computer-implemented method of claim 2, where game-clip preview images having the first size and game-clip preview images having the second size have a same aspect ratio.

4. The computer-implemented method of claim 3, where the aspect ratio is 16×9.

5. The computer-implemented method of claim 3, where game-clip preview images having the first size alternate between being aligned above and being aligned below two side-by-side game-clip preview images having the second size.

6. The computer-implemented method of claim 2, where game clips having a place in a repeating pattern are visually represented with game-clip preview images having the first size, while all other game clips having a place out of the repeating pattern are visually represented with game-clip preview images having the second size.

7. The computer-implemented method of claim 6, where a place of an n^{th} number in the repeating pattern is:
$${a}_{n} = \frac{6 ( m + 1 ) ( n - 1 ) + 3 + {( - 1 )}^{n}}{2}$$
where m is an order of spacing within the spatially-sorted array.

8. The computer-implemented method of claim 1, where adding the game clip to the first place in the ordered listing of game clips includes adding a game clip from a currently playing game responsive to a user command.

9. The computer-implemented method of claim 8, where the user command is a voice command spoken while the currently playing game is being played.

10. The computer-implemented method of claim 8, where the user command is a gesture command recognized with a camera while the currently playing game is being played.

11. The computer-implemented method of claim 8, where each of the game-clip preview images in the spatially-sorted array is a thumbnail from a corresponding game clip.

12. A computer-implemented user interface for visually presenting media content items available for time-shifted playback, the user interface comprising:
a first plurality of preview images having an aspect ratio and a first size; and
a second plurality of preview images having the aspect ratio and a second size, smaller than the first size;
each preview image visually representing a different media content item available for time-shifted playback;
each preview image spatially-sorted in an array according to a temporal order with which that media content item is added to the array; and
preview images having the first size alternating between being aligned above and being aligned below two side-by-side preview images having the second size.

13. The computer-implemented user interface of claim 12, where the first plurality of preview images includes preview images having spatially-sorted positions in a repeating pattern and the second plurality of preview images does not include preview images having spatially-sorted positions in the repeating pattern.

14. The computer-implemented user interface of claim 13, where a spatially-sorted position of an n^{th} preview image in the repeating pattern is:
$${a}_{n} = \frac{6 ( m + 1 ) ( n - 1 ) + 3 + {( - 1 )}^{n}}{2}$$
where m is an order of spacing within the array.

15. The computer-implemented user interface of claim 12, where the aspect ratio is 16×9.

16. The computer-implemented user interface of claim 12, where each preview image is a thumbnail of a game clip available for time-shifted playback.

17. A computer-implemented user interface for visually presenting media content items available for time-shifted playback, the user interface comprising:
a first preview image visually representing a most-recent addition to an ordered listing of media content items accessible for time-shifted playback;
a second preview image visually representing a second-most-recent addition to the ordered listing of media content items accessible for time-shifted playback, the second preview image left-aligned with and below the first preview image;
a third preview image visually representing a third-most-recent addition to the ordered listing of media content items accessible for time-shifted playback, the third preview image right-aligned with and below the first preview image, top-and-bottom-aligned with and to the right of the second preview image, and having a same size as the second preview image;
an n^{th}−1 preview image visually representing an n^{th}-minus-one-most-recent addition to the ordered listing of media content items accessible for time-shifted playback, the n^{th}−1 preview image top-aligned with and to the right of the first preview image and having a same size as the second and third preview images; and
an n^{th} preview image visually representing an n^{th}-most-recent addition to the ordered listing of media content items accessible for time-shifted playback, the n^{th} preview image bottom-aligned with and to the right of the second and third preview images and having a same size as the first preview image.

18. The computer-implemented user interface of claim 17, where each preview image is a thumbnail of a game clip available for time-shifted playback.

19. The computer-implemented user interface of claim 17, where the n^{th} preview image is the eighth preview image.

20. The computer-implemented user interface of claim 17, where the first preview image, second preview image, third preview image, n^{th}−1 preview image, and n^{th} preview image each have a 16×9 aspect ratio.
